(19) United States
(12) Patent Application Publication
(10) Pub. No.: US 2011/0148824 A1
(43) Pub. Date: Jun. 23, 2011

(54) OPTICAL PEN

(75) Inventor: Chris Haverty, Portland, OR (US)

(73) Assignee: SEIKO EPSON CORPORATION, Shinjuku-ku (JP)

(21) Appl. No.: 12/842,889

(22) Filed: Jul. 23, 2010

Related U.S. Application Data
(60) Provisional application No. 61/228,488, filed on Jul. 24, 2009.

(51) Int. Cl. G06F 3/033

(52) U.S. Cl. 345/179

(57) ABSTRACT

An optical pen having an extending tip is disclosed. The tip is located on the optical pen so as not to obstruct input light to the optical pen. The tip also provides tactile feedback to a user upon the tip contacting a viewing surface.

### CROSS-REFERENCES TO RELATED APPLICATIONS

This application claims the benefit of U.S. Provisional Application No. 61/228,488, filed Jul. 24, 2009, the entirety of which is incorporated by reference herein.

### BACKGROUND OF THE INVENTION

The present application relates to an optical pen, and more specifically to an optical pen that provides a tactile writing experience.

Image display devices may be used in a variety of environments. For example, image display devices such as projectors, televisions, monitors, etc., may be adapted to display images, including text, graphics, video images, still images, presentations, etc. Such image display devices may be found in educational environments, business facilities, conference rooms, meeting facilities, and the like.

Image display devices may be used in a variety of environments such as educational settings (e.g., classrooms), business facilities, conference rooms, and the like. For image display devices such as projectors, large format viewing may be permitted, for example, by the image display device projecting an image onto a viewing surface that is viewable by one or more audience members. A presenter giving a presentation with such an image display device needs to be able to annotate text and/or images displayed on the viewing surface while giving the presentation. Accordingly, an input device may be configured to interact with the image display device so as to allow such real-time annotations. For example, an optical pen may be used to virtually “write” on the viewing surface, and the image display device may in response display “writing” on the image. As such, the image display device and the viewing surface may collectively serve as an electronic whiteboard, wherein the optical pen serves as an electronic whiteboard pen.

Writing, drawing, etc. with such an optical pen may be more challenging in comparison to a traditional writing instrument, as the user does not have a physical surface to write against. For example, when “writing” in air with an optical pen, it may be difficult to control pen strokes, control penmanship and handwriting, keep track of prior positions of the optical pen, and the like.

### BRIEF SUMMARY OF THE INVENTION

Various embodiments related to a tip for an optical pen are disclosed herein. One disclosed embodiment includes a tip for an optical pen, wherein the tip is located on the optical pen so as not to obstruct input light to the optical pen, and wherein the tip provides tactile feedback to a user upon the tip contacting a viewing surface.

One embodiment of the invention provides an optical pen. The optical pen may include an elongated housing having a distal end. An optical sensor may be located within the housing and configured to receive input light from a viewing surface through a distal opening at the distal end of the housing. A tip may extend from the distal end of the housing and may be positioned adjacent to the distal opening. The tip may be positioned to not obstruct the input light to the optical pen when the most distal portion of the tip is in contact with the viewing surface.

In one aspect of the optical pen, the most distal portion of the tip may provide tactile feedback to a user upon the tip contacting a viewing surface.

In another aspect of the optical pen, the tip may include an elongated member and the most distal portion of the tip comprises a spherical surface.

In another aspect of the optical pen, the most distal portion of the tip may have a larger cross-sectional area as compared to the elongated member.

In another aspect of the optical pen, the tip may include a wedge with a decreasing cross-sectional area towards the most distal portion of the tip.

In another aspect of the optical pen, the tip may include a switch that is actuated by interfacing with the viewing surface.

In another aspect of the optical pen, the switch may be a pushbutton switch, a pull/push switch, a rocker switch, a rotary switch, a toggle switch, or slideable switch.

In another aspect of the optical pen, the switch may be integrated into the tip and actuated by a button on the tip.

In another aspect of the optical pen, the switch may be a depressible button which is actuated by depressing the tip against the viewing surface.

In another aspect of the optical pen, the optical sensor may be a photodetector.

In another aspect of the optical pen, a lens may be attached to the housing and positioned to focus the input light onto the photodetector.

In another aspect of the optical pen, a wireless transmitter may be located within the housing and electrically connected to the optical sensor.

Another embodiment of the invention provides a display system. The display system may include an image display device which includes an image generation device for projecting an image. A processor of the image display device may be configured to receive optical signal data from an input device and calculate location data for indicating where the input device is pointing on the image. A computing system may be configured to receive the location data from the image display device and send image data to the image display device. The image data may be based on the location data. The display system may include an optical pen device including an elongated housing having a distal end. An optical sensor may be located within the housing and configured to receive input light from a viewing surface through a distal opening at the distal end of the housing. A wireless transmitter may be located within the housing and electrically connected to the optical sensor. The wireless transmitter may be configured to be in wireless communication with the image display device. A tip may extend from the distal end of the housing and may be positioned adjacent to the distal opening. The tip may be positioned to not obstruct the input light to the optical pen when the most distal portion of the tip is in contact with the viewing surface.

In one aspect of the display system, the tip may include a switch that is actuated by interfacing with the viewing surface.

In another aspect of the display system, actuation of the switch may cause an activation signal to be sent from the wireless transmitter to the image display device.

In another aspect of the display system, the activation signal may include a left mouse button signal that is sent to the computing system.

In another aspect of the display system, the activation signal may invoke a contextual menu of selectable options from the computing system which is displayed by the image display device.

In another aspect of the display system, the tip may include an elongated member and the most distal portion of the tip may include a spherical surface.

In another aspect of the display system, the most distal portion of the tip may have a larger cross-sectional area as compared to the elongated member.

In another aspect of the display system, the tip may include a wedge with a decreasing cross-sectional area towards the most distal portion of the tip.

### BRIEF DESCRIPTION OF THE DRAWINGS

FIG. 1 shows a block diagram of an embodiment of an image display system.

FIG. 2 shows a schematic depiction of an embodiment of an image display system.

FIG. 3 shows a schematic depiction of an example optical pen including an embodiment of a tip.

FIG. 4 shows a schematic depiction of another example optical pen including an embodiment of a tip.

FIG. 5 shows a schematic depiction of yet another example optical pen including an embodiment of a tip.

### DETAILED DESCRIPTION OF THE INVENTION

As disclosed herein, an optical pen may be used to virtually “write” on the viewing surface, and the image display device may in response display “writing” on the image. As such, the image display device and viewing surface may collectively serve as an electronic whiteboard, wherein the optical pen serves as an electronic whiteboard pen. Controlling such an optical pen in a manner consistent with writing, drawing and other such precise manipulation may be challenging. These issues may be addressed by the embodiments of a tip for an optical pen disclosed herein, which provides a tactile writing experience when using the optical pen. It can be appreciated that the herein-described examples are non-limiting and are provided to aid in illustrating various embodiments of a tip for an optical pen.

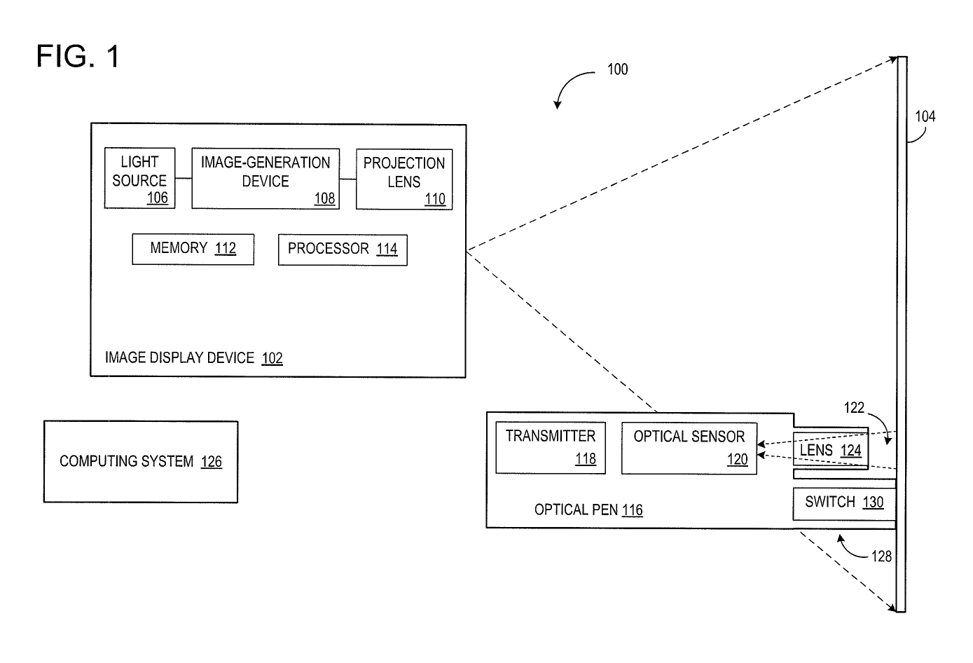

FIG. 1 shows an embodiment of an image display system 100. The image display system 100 may include an image display device 102 configured to project an image onto a viewing surface 104. For example, the image display system 100 may be a system configured for displaying an image in a large display format for group viewing. As described and illustrated herein, an image display device may be a projection device, such as a front projecting device. However, it should be understood that the image display device may be another type of display device, including, but not limited to a front projection system, a rear-projection system, etc. In other embodiments, the display device may be an LCD system, laser system, large format display device, etc. As an example, image display device 102 may be a projector. Accordingly, the image display device 102 may utilize any suitable technology for displaying the image on the viewing surface 104, such as digital light processing.

The image display device 102 may include a light source 106, configured to direct light toward an image-generation device 108. In some embodiments, the light source 106 may include a lamp positioned within a reflector that may be configured to direct most of the emitted light along an optical path of the system. The light source 106 may include any suitable type of lamp or light source, including but not limited to, metal halide lamps and ultra-high-pressure (UHP) arc lamps, lasers, light emitting diodes (LED), organic light emitting diodes, etc. The light source 160 may also include one or more filters, such as an infrared (IR), or ultraviolet (UV) filter, to filter out unwanted parts of the emission spectra of the lamp.

As described above, the image-generation device 108 may be configured to receive light from the light source 106, and in response, generate an image. The image-generation device 108 may include an optical engine, image-producing element, filters, color wheels, lenses, mirrors, integrators, condensers, and other suitable optical elements. Such elements may be configured to generate an image. For example, the image-generation device 108 may include an image-producing element, such as, but not limited to, a digital micromirror (DMD), an LCD panel, or any other suitable image source. In some embodiments, the image-producing element may be configured to project light toward one or more lenses, mirrors or other optics, which, in turn, may be configured to project light toward the viewing surface. In some embodiments, a projection lens 110 may be configured to display the image on the viewing surface 104. Non-limiting examples of the viewing surface may include a screen, a wall, etc.

The image display device 102 may further include memory 112. The memory 112 may be operatively coupled to a processor 114, such that processor 114 may execute instructions stored on memory 112. The image display device 102 may be configured to receive data from an input device, such as optical pen 116.

The optical pen 116 may include a transmitter 118 for sending data to image display device 102. As a non-limiting example, the transmitter 118 may be a radio frequency transmitter. The optical pen 116 may further include an optical sensor 120 for receiving light of the image displayed on the viewing surface 104 that has reflected back from the viewing surface 104, i.e., reflected image light. As an example of reflected image light, FIG. 1 illustrates optical input 122. As a non-limiting example, the optical sensor 120 configured to receive the optical input 122 may be a photodetector. Reflected image light may first enter through a lens 124 prior to being received by optical sensor 120. It should be understood that optical pen 116 is a non-limiting example of an optical pen, and other such optical pens may be used as input devices within image display system 100.

In some embodiments, image display device 102 may be further configured to embed patterns within the image. Accordingly, the optical pen 116 may be further configured to, upon receiving reflected image light via optical sensor 120, read these patterns as a light level to derive optical signal data. The optical pen 116 may then be further configured to transmit the optical signal data to image display device 102, for example, as a wireless transmission or a wired transmission. The image display device 102 may be further configured to, through a series of patterns, calculate a location of optical pen 116 within the image projected onto viewing surface 104. Upon calculating the location, (i.e., where, in the projected image, the optical pen is pointing), the image display device 102 may be further configured to transmit location data to a computing system, such as computing system 126.

As a non-limiting example, the location data may be transmitted to the computing system as mouse coordinates. In response, the computing system 126 may interact with image display device 102 to display image data at the location. Thus, the optical pen 116 may be used for writing, drawing, etc. so as to utilize image display system 100 as an electronic whiteboard. It should be understood that the image display system 100 is a non-limiting example of an image display system, and other embodiments of image display system may include an optical pen 116 configured to interact with an image display device 102 in another suitable manner.

The optical pen 116 may be further configured to have a supporting, protruding tip extending off of a front distal end of the optical pen, such as protruding tip 128. The protruding tip 128 may be adapted to contact or engage viewing surface 104 so as to mimic the surface contact and tactile feedback felt when using a tradition writing implement, such as a traditional whiteboard marker. As such, the protruding tip 128 may improve handwriting created with optical pen 116 by providing control and feedback to the user. Further, the protruding tip 128 may be positioned at the front end of optical pen 116 so as not to block light from optical input 122. As shown, the protruding tip 128 does not block the optical input 122 when the protruding tip 128 is in contact with the viewing surface. This is shown with an approximately transverse arrangement of the protruding tip 128 with respect to the viewing surface 104. However, the protruding tip 128 can be structurally configured to not block the optical input light 122 when placed in a typical writing angle with respect to the viewing surface 104, for example, 0-45 degrees. In some embodiments, the protruding tip 128 is constructed from a relatively transparent material and/or include one or more openings to enable optical input light 122 to pass therethrough.

In some embodiments, protruding tip 128 may further include a switch 130 corresponding to auxiliary options interpretable by the computing system. The optical pen 116 can be configured to send an activation signal to the image display device via a user actuation of the switch 130. The activation signal is ultimately transmitted to the computing system 126 to indicate a user command, such as a mouse click, writing command, or drawing command. The activation signal may be sent along with the location data by the 118 transmitter. In some embodiments, the switch 130 may invoke via the activation signal a contextual menu in a user interface of the computing system 126 and/or image display device 102, which contains options specifically tailored to the interface element over which the optical pen is positioned. As an example, switch 130 may act as a left mouse button when using the optical pen as a mouse.

Further, the switch 130 may be configured to be actuated in any suitable manner. As non-limiting example, switch 130 may be pushbutton switch, a pull/push switch, a rocker switch, a rotary switch, a toggle switch, a slideable switch, a depressible button, etc. As an example, the switch 130 may be integrated into the protruding tip 128 and actuated by a button on protruding tip 128. As another example, the switch 130 may be a depressible button actuated by depressing the protruding tip 128.

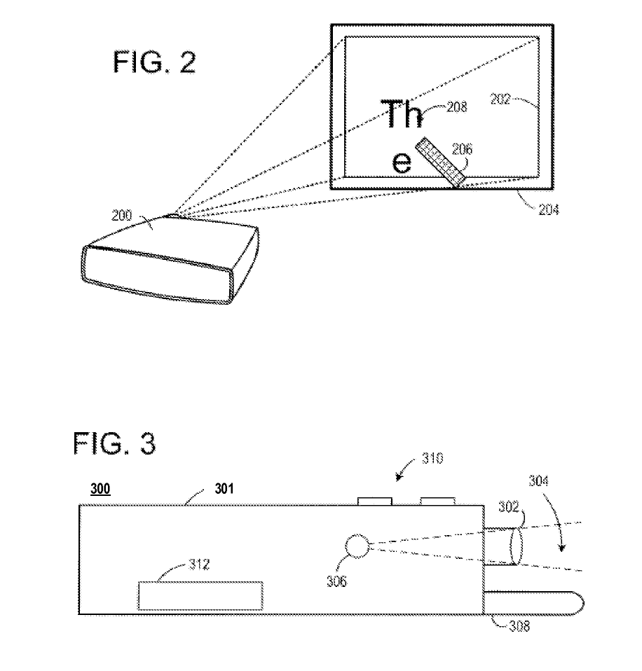

FIG. 2 illustrates an image display device, namely projector 200, configured to project an image 202 onto a viewing surface 204. Optical pen 206 may then be configured to interact with projector 200 to annotate image 202 as depicted at 208.

FIG. 3 shows a schematic depiction of an embodiment of an optical pen 300 having an elongated housing 301. As an example, optical pen 300 may include a lens 302 attached to the housing 301 for receiving input light 304 reflected from a viewing surface where an image is being projected. Upon receiving input light 304, the lens 302 may direct light to an optical sensor such as photodetector 306. The optical pen 300 may further have a protruding tip 308 configured to contact the viewing surface so as to yield tactile feedback to a user of optical pen 300 when in contact with a viewing surface, so as to mimic tactile feedback of a traditional writing implement.

A protruding tip 308 may be positioned adjacent to lens 302 so as not to block input light 304. In some embodiments, the protruding tip 308 may include a switch, wherein actuation of the switch indicates a control that is interpretable by an image display device and/or computing system. The optical pen 300 may further include buttons 310, wherein each button of buttons 310 may be associated with a control interpretable by an image display device and/or computing system, such that actuation of that button communicates the control, via respective activation signals, to the image display device and/or computing system. For example, the buttons 310 may be mouse buttons. In some embodiments, the protruding tip 308 may include a switch for accessing auxiliary options. For example, the switch may be configured as a left mouse button. Further, in some embodiments, optical pen 300 may be a battery-operated device, powered by battery device 312. It can be appreciated that the optical pen 300 is one embodiment of an optical pen, and that other embodiments of an optical pen having a protruding tip adapted to provide tactile feedback to a user are within the scope of this disclosure.

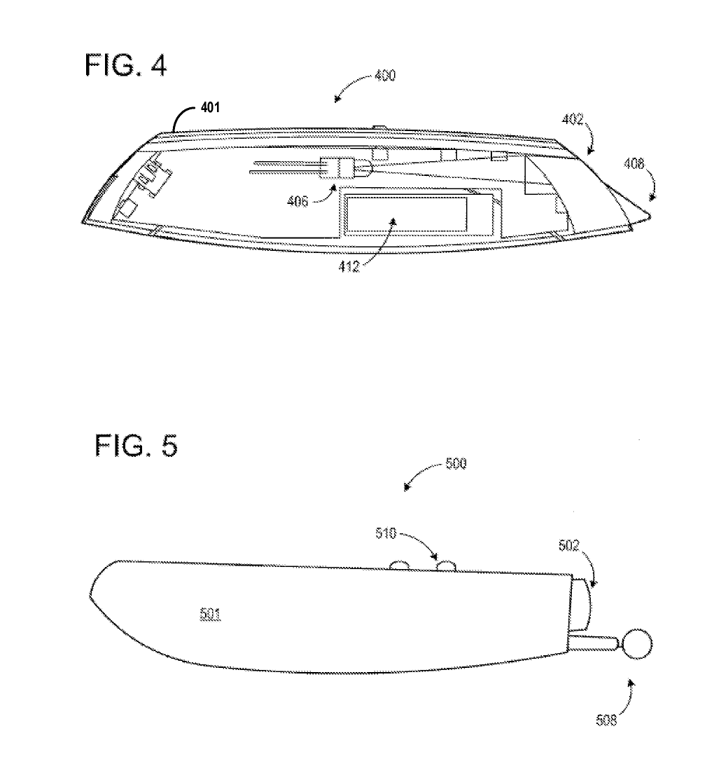

FIG. 4 shows a schematic depiction of another embodiment of an optical pen 400 having an elongated housing 401. The housing 401 as shown is curved to provide a comfortable gripping area. Optical pen 400 may include a lens 402 for receiving input reflected from a viewing surface where an image is being projected. The lens 402 may direct light to an optical sensor 406. Optical pen 400 may further have a protruding tip 408, configured to contact the viewing surface so as to provide tactile feedback to a user of optical pen 400 that mimics that of a traditional writing implement. The protruding tip 408 may be positioned adjacent to lens 402 so as not to block input light.

As shown, the protruding tip 408 has a wedge shaped cross-sectional area that gradually decreases to a distal most portion. The cross-sectional area of the wedge also decreases in a direction away from the lens 402. This non-symmetrical and downward bias of the cross-sectional area of the wedge helps prevent the protruding tip from blocking input light to the lens 402. In some embodiments, protruding tip 408 may include a switch for accessing auxiliary options such as those corresponding to a left mouse button. Further, in some embodiments, optical pen 400 may be a battery operated device, powered by battery device 412.

FIG. 5 shows a schematic depiction of another embodiment of an optical pen 500, having an elongated housing 501. The housing 501 as shown is curved to provide a comfortable gripping area. The optical pen 500 may include a lens 502 for receiving input reflected from a viewing surface where an image is being projected. The optical pen 500 may further have a protruding tip 508, configured to contact the viewing surface so as to yield tactile feedback to a user of optical pen 500 that mimics that of a traditional writing implement. The protruding tip 508 may be positioned adjacent to lens 502 so as not to block input light.

As shown, the protruding tip 508 has an elongated member coupled to a distal most portion with a spherical surface. The distal most portion can have a cross-sectional area which is larger than the cross-sectional area of the elongated member. The optical pen 500 may further include buttons 510 associated with controls interpretable by an image display device and/or computing system, such that actuation of that button communicates the control, via respective activation signals, to the image display device and/or computing system. For example, the buttons 510 may be configured as mouse buttons. In some embodiments, the protruding tip 508 may include a switch for accessing auxiliary options, such as those corresponding to a left mouse button.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein.

Inventions embodied in various combinations and subcombinations of features, functions, elements, and/or properties may be claimed in a related application. Such claims, whether they are directed to a different invention or directed to the same invention, whether different, broader, narrower or equal in scope to any original claims, are also regarded as included within the subject matter of the inventions of the present disclosure.

What is claimed is:

1. An optical pen, comprising:
an elongated housing having a distal end;
an optical sensor located within the housing and configured to receive input light from a viewing surface through a distal opening at the distal end of the housing;
a tip extending from the distal end of the housing and being positioned adjacent to the distal opening, the tip being positioned to not obstruct the input light to the optical pen when the most distal portion of the tip is in contact with the viewing surface.

2. The optical pen of claim 1, wherein the most distal portion of the tip provides tactile feedback to a user upon the tip contacting a viewing surface.

3. The optical pen of claim 1, wherein the tip comprises an elongated member and the most distal portion of the tip comprises a spherical surface.

4. The optical pen of claim 3, wherein the most distal portion of the tip has a larger cross-sectional area as compared to the elongated member.

5. The optical pen of claim 1, wherein the tip comprises a wedge with a decreasing cross-sectional area towards the most distal portion of the tip.

6. The optical pen of claim 1, wherein the tip comprises a switch that is actuated by interfacing with the viewing surface.

7. The optical pen of claim 6, wherein the switch is a pushbutton switch, a pull/push switch, a rocker switch, a rotary switch, a toggle switch, or slideable switch.

8. The optical pen of claim 6, wherein the switch is integrated into the tip and actuated by a button on the tip.

9. The optical pen of claim 6, wherein the switch is a depressible button which is actuated by depressing the tip against the viewing surface.

10. The optical pen of claim 1, wherein the optical sensor is a photodetector.

11. The optical pen of claim 10, further comprising:
a lens attached to the housing and positioned to focus the input light onto the photodetector.

12. The optical pen of claim 1, further comprising:
a wireless transmitter located within the housing and being electrically connected to the optical sensor.

13. A display system comprising:
an image display device comprising:
an image generation device for projecting an image;
a processor configured to receive optical signal data from an input device and calculate location data for indicating where the input device is pointing on the image,
wherein a computing system is configured to receive the location data from the image display device and send image data to the image display device, the image data being based on the location data;
an optical pen device comprising:
an elongated housing having a distal end;
an optical sensor located within the housing and configured to receive input light from a viewing surface through a distal opening at the distal end of the housing;
a wireless transmitter located within the housing and being electrically connected to the optical sensor, the wireless transmitter being in wireless communication with the image display device
a tip extending from the distal end of the housing and being positioned adjacent to the distal opening, the tip being positioned to not obstruct the input light to the optical pen when the most distal portion of the tip is in contact with the viewing surface.

14. The optical pen of claim 13, wherein the tip comprises a switch that is actuated by interfacing with the viewing surface.

15. The display system of claim 14, wherein actuation of the switch causes an activation signal to be sent from the wireless transmitter to the image display device.

16. The tip for an optical pen of claim 15, wherein the activation signal comprises a left mouse button signal that is sent to the computing system.

17. The tip for an optical pen of claim 15, wherein activation signal invokes a contextual menu of selectable options from the computing system which is displayed by the image display device.

18. The display system of claim 13, wherein the tip comprises an elongated member and the most distal portion of the tip comprises a spherical surface.

19. The optical pen of claim 18, wherein the most distal portion of the tip has a larger cross-sectional area as compared to the elongated member.

20. The optical pen of claim 13, wherein the tip comprises a wedge with a decreasing cross-sectional area towards the most distal portion of the tip.
